(19) United States
(12) Patent Application Publication
(10) Pub. No.: US 2012/0154400 A1
(43) Pub. Date: Jun. 21, 2012

(54) METHOD OF REDUCING NOISE IN A VOLUME-RENDERED IMAGE

(75) Inventor: Erik Normann Steen, Moss (NO)

(73) Assignee: GENERAL ELECTRIC COMPANY, Schenectady, NY (US)

(21) Appl. No.: 12/973,236

(22) Filed: Dec. 20, 2010

(51) Int. Cl. G06T 17/00

(52) U.S. Cl. 345/424

(57) ABSTRACT

A method of reducing noise in a volume-rendered image includes generating a volume-rendered image from data, identifying a pixel location of suspected noise in the volume-rendered image, and calculating a voxel location that corresponds to the pixel location and intersects a rendered surface in voxel space. The method includes implementing a region-growing algorithm using the voxel location as a seed point to identify a plurality of voxels in a suspected noisy region. The method includes modifying the data to generate modified data by assigning lower opacity values to the plurality of voxels. The method includes generating a modified volume-rendered image from the modified data and displaying the modified volume-rendered image.

### FIELD OF THE INVENTION

This disclosure relates generally to three-dimensional volume-rendered imaging and specifically to a technique for identifying and adjusting the opacity values of voxels in a suspected noisy region.

### BACKGROUND OF THE INVENTION

A conventional volume-rendered image is typically a projection of three-dimensional (3D) data onto a two-dimensional (2D) viewing plane. Typically the volume-rendered image will be generated by a method such as ray tracing, which involves mapping a weighted sum of volume pixel elements, or voxels, along rays that originate from pixel locations in the viewing plane. Volume-rendered images are commonly used to view 3D medical imaging data. Typically, each of the voxels are assigned a value and a corresponding opacity value based on the information acquired by the medical imaging system. Commonly, the opacity value is a function of the voxel value. For example, the value of each voxel in computed tomography data typically represents an x-ray attenuation value; the value of each voxel in an magnetic resonance imaging data typically represents proton density; and the value of each voxel in an ultrasound imaging data typically represents either acoustic density in a B-mode or rate of flow in a color-mode. In color-mode, the opacity value may for instance be related to the power of the color flow signal.

Typical 3D data includes noise. Noise in a volume-rendered image may result when one or more voxels are incorrectly assigned a value that is not indicative of the anatomy being examined. In ultrasound, acoustic noise such as reverberations may make it hard to create a 3D rendering without artifacts. When viewing a volume-rendered image generated from 3D data, noise may obscure all or a portion of the structure being imaged. For example, one frequent problem with volume-rendered ultrasound images is the presence of noise when imaging a ventricle of the heart. The noise can make surfaces, such as the ventricle, difficult or impossible to visualize with standard rendering techniques like ray tracing.

Conventional techniques for dealing with noise in 3D datasets are largely manual and they require a large amount of user time in order to work satisfactorily. For example, conventional rendering software may allow the user to view various cut-planes through the 3D data in addition to volume rendering. Typically, rendering software will allow the user to view surface intersections with the cut-planes. According to one known technique to reduce the effects of noise, the user needs to manually select one or more cut planes from which the noise in the volume-rendered image is suspected to originate. The pixels of the volume-rendered image represent a weighted-sum of voxel opacity values and it can therefore be difficult to identify which pixels in the cut-planes correspond to noisy pixels in the volume rendered image. As such, the user may need to select multiple cut-planes before properly identifying the noisy voxels. On a conventional system the user is required to utilize a user interface device in order to select the desired cut-planes. Then, according to conventional techniques, the user needs to manually or semi-automatically adjust the opacity values of the voxels suspected of containing noise. Finally the user needs to check the volume-rendered image to see if the noisy voxels were correctly identified. All of the aforementioned steps add unnecessary time and complexity to each imaging procedure. The process of reducing the noise in a volume-rendered image can be very burdensome to the operator, particularly when dealing with large datasets. For these and other reasons, there is a need for an improved method for removing noise from 3D data and volume-rendered images generated from 3D data.

### BRIEF DESCRIPTION OF THE INVENTION

The above-mentioned shortcomings, disadvantages and problems are addressed herein which will be understood by reading and understanding the following specification.

In an embodiment, a method of reducing noise in a volume-rendered image includes generating a volume-rendered image from data, identifying a pixel location of suspected noise in the volume-rendered image, and calculating a voxel location that corresponds to the pixel location and intersects a rendered surface in voxel space. The method includes implementing a region-growing algorithm using the voxel location as a seed point to identify a plurality of voxels in a suspected noisy region. The method includes modifying the data to generate modified data by assigning lower opacity values to the plurality of voxels. The method includes generating a modified volume-rendered image from the modified data and displaying the modified volume-rendered image.

In another embodiment, a method of reducing noise in a volume-rendered image includes generating a volume-rendered image from data, identifying a pixel location of suspected noise in the volume-rendered image, and accessing a depth buffer to obtain a distance from the pixel location to a rendered surface. The method includes identifying a voxel location associated with the pixel location based on the distance. The method includes implementing a region-growing algorithm using the voxel location as a seed point in order to identify a plurality of voxels in a suspected noisy region. The method includes modifying the data to generate modified data by assigning lower opacity values to the plurality of voxels. The method includes generating a modified volume-rendered image based on the modified data and displaying the modified volume-rendered image.

In another embodiment, a method of reducing noise in a volume-rendered image includes accessing first data, the first data comprising three-dimensional data of a structure. The method includes identifying a voxel location within a suspected noisy region in the first data. The method includes accessing second data, the second data including three-dimensional data of the structure acquired after the first data. The method includes implementing a region-growing algorithm on the second data using the voxel location as a seed point in order to identify a plurality of voxels. The method includes modifying the second data to generate modified second data by assigning lower opacity values to the plurality of voxels. The method includes generating a volume-rendered image based on the modified second data and displaying the volume-rendered image.

Various other features, objects, and advantages of the invention will be made apparent to those skilled in the art from the accompanying drawings and detailed description thereof.

### BRIEF DESCRIPTION OF THE DRAWINGS

FIG. 1 is a schematic diagram of an ultrasound imaging system in accordance with an embodiment;

FIG. 2 is a flow chart illustrating a method in accordance with an embodiment;

FIG. 3 is a schematic representation showing a perspective view of a viewing plane and a rendered surface; and

FIG. 4 is a flow chart illustrating a method in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

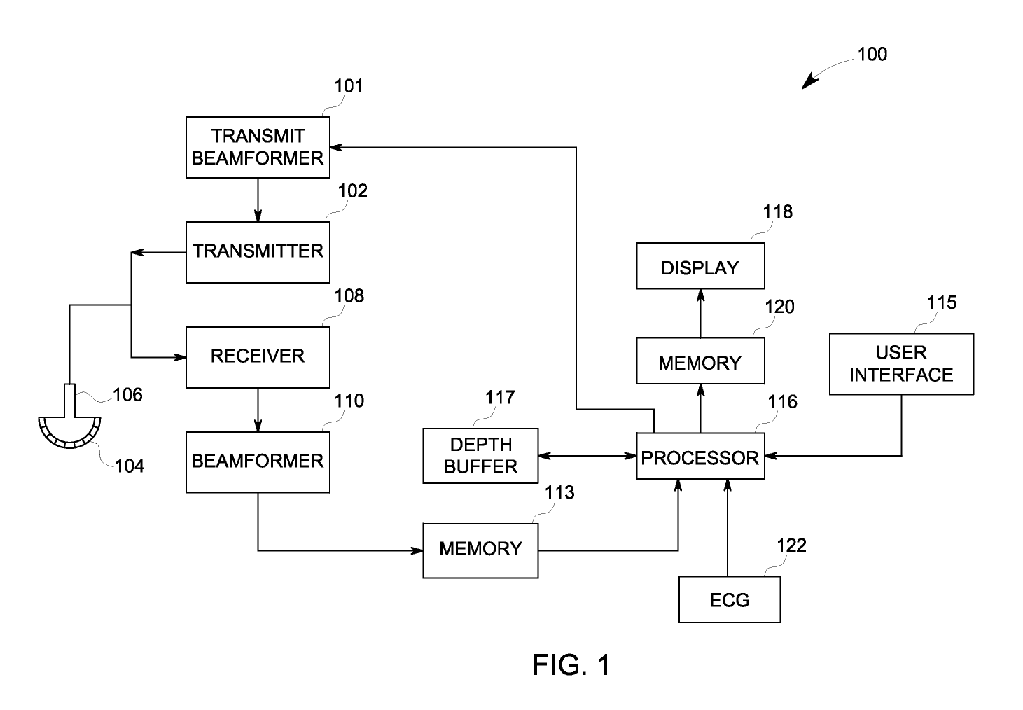

FIG. 1 is a schematic diagram of an ultrasound imaging system 100. The ultrasound imaging system 100 includes a transmit beamformer 101 and a transmitter 102 that drive transducer elements 104 within a probe 106 to emit pulsed ultrasonic signals into a body (not shown). A variety of geometries of probes and transducer elements may be used. The pulsed ultrasonic signals are back-scattered from structures in the body, like blood cells or muscular tissue, to produce echoes that return to the transducer elements 104. The echoes are converted into electrical signals, or ultrasound data, by the transducer elements 104 and the electrical signals are received by a receiver 108. According to some embodiments, the probe 106 may contain electronic circuitry to do all or part of the transmit and/or the receive beamforming. For example, all or part of the transmit beamformer 101, the transmitter 102, the receiver 108 and the beamformer 110 may be situated within the probe 106. The terms “scan” or “scanning” may also be used in this disclosure to refer to acquiring data through the process of transmitting and receiving ultrasonic signals. The electrical signals representing the received echoes are passed through a beamformer 110 that outputs ultrasound data. A memory 113 is connected to the beamformer 110 and may be used to store ultrasound data after the data has been beamformed by the beamformer 110. The memory 113 may also function as a buffer to store portions of a frame of ultrasound data while waiting for the rest of the frame of ultrasound data to be received by the receiver 108. A user interface 115 may be used to control operation of the ultrasound imaging system 100, including, to control the input of patient data, to change a scanning or display parameter, and the like. The user interface 115 may include controls such as a keyboard, a mouse, a trackball, a touch screen, and the like.

The ultrasound imaging system 100 also includes a processor 116 to control the transmit beamformer 101, the transmitter 102, the receiver 108, and the beamformer 110. The processor 116 is in electronic communication with the probe 106. The processor 116 controls which of the transducer elements 104 are active and the shape of a beam emitted from the probe 106. The processor 116 is also in electronic communication with a display 118, and the processor 116 may process the data into images for display on the display 118. The processor 116 may comprise a central processor (CPU) according to an embodiment. According to other embodiments, the processor 116 may comprise other electronic components capable of carrying out processing functions, such as a digital signal processor, a field-programmable gate array (FPGA) or a graphic board. According to other embodiments, the processor 116 may comprise multiple electronic components capable of carrying out processing functions. For example, the processor 116 may comprise two or more electronic components selected from a list of electronic components including: a central processor, a digital signal processor, a field-programmable gate array, and a graphic board. According to another embodiment, the processor 116 may also include a complex demodulator (not shown) that demodulates the RF data and generates raw data. In another embodiment the demodulation can be carried out earlier in the processing chain. The processor 116 is adapted to perform one or more processing operations according to a plurality of selectable ultrasound modalities on the data. The ultrasound data may be processed in real-time during a scanning session as the echo signals are received. For the purposes of this disclosure, the term “real-time” is defined to include a procedure that is performed without any intentional delay. For example, an embodiment may acquire and display images with a real-time frame-rate of 7-20 frames/sec. However, it should be understood that the real-time frame rate may be dependent on the length of time that it takes to acquire each frame of ultrasound data for display. Accordingly, when acquiring a relatively large volume of data, the real-time frame-rate may be slower. Thus, some embodiments may have real-time frame-rates that are considerably faster than 20 frames/sec while other embodiments may have real-time frame-rates slower than 7 frames/sec. The ultrasound information may be stored temporarily in the memory 113 during a scanning session and processed in less than real-time in a live or off-line operation.

The ultrasound imaging system 100 may continuously acquire data at a frame-rate of, for example, 10 Hz to 30 Hz. Images generated from the data may be refreshed at a similar frame rate. Other embodiments may acquire and display data at different rates. For example, some embodiments may acquire data at a frame rate of less than 10 Hz or greater than 30 Hz depending on the size of the volume and the intended application. A memory 120 is included for storing processed frames of acquired data. In an exemplary embodiment, the memory 120 is of sufficient capacity to store at least several seconds worth of frames of ultrasound data. The frames of data are stored in a manner to facilitate retrieval thereof according to its order or time of acquisition. The memory 120 may comprise any known data storage medium. There is an ECG 122 attached to the processor 116 of the ultrasound imaging system 100 shown in FIG. 1. The ECG may be connected to the patient and provides cardiac data from the patient to the processor 116 for use during the acquisition of gated data. The ultrasound imaging system 100 also includes a depth buffer 117 connected to the processor 116. The depth buffer 117 may be used when processing 3D and 4D ultrasound data. According to an embodiment, the depth buffer 117 is a memory configured to store distances from the viewing plane to the rendered surface in a direction perpendicular to the viewing plane for each of the pixels in an image. The depth buffer 117 is used during the process of converting 3D ultrasound data to a volume-rendered image for display on the display 118.

Optionally, embodiments of the present invention may be implemented utilizing contrast agents. Contrast imaging generates enhanced images of anatomical structures and blood flow in a body when using ultrasound contrast agents including microbubbles. After acquiring data while using a contrast agent, the image analysis includes separating harmonic and linear components, enhancing the harmonic component and generating an ultrasound image by utilizing the enhanced harmonic component. Separation of harmonic components from the received signals is performed using suitable filters. The use of contrast agents for ultrasound imaging is well-known by those skilled in the art and will therefore not be described in further detail.

In various embodiments of the present invention, data may be processed by other or different mode-related modules by the processor 116 (e.g., B-mode, Color Doppler, M-mode, Color M-mode, spectral Doppler, TVI, strain, strain rate, and the like) to form 2D or 3D data. For example, one or more modules may generate B-mode, color Doppler, M-mode, color M-mode, spectral Doppler, TVI, strain, strain rate and combinations thereof, and the like. The image beams and/or frames are stored and timing information indicating a time at which the data was acquired in memory may be recorded. The modules may include, for example, a scan conversion module to perform scan conversion operations to convert the image frames from coordinates beam space to display space coordinates. A video processor module may be provided that reads the image frames from a memory and displays the image frames in real time while a procedure is being carried out on a patient. A video processor module may store the image frames in an image memory, from which the images are read and displayed.

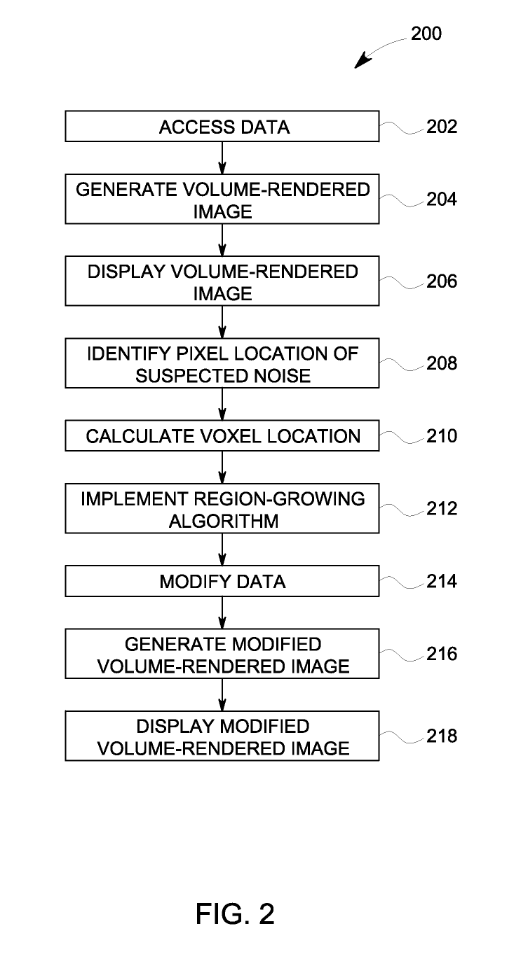

FIG. 2 is a flow chart illustrating a method 200 in accordance with an embodiment. The method 200 may be implemented with a medical imaging system, such as the ultrasound imaging system 100 (shown in FIG. 1). The individual blocks represent steps that may be performed in accordance with the method 200. The technical effect of the method 200 is the display of a modified volume-rendered image generated from modified data. Hereinafter, the method 200 will be described according to an exemplary embodiment using an ultrasound imaging system, but it should be appreciated that the method 200 may be performed using a medical imaging system from a different imaging modality. For example, the method 200 may be performed with a medical imaging system selected from the nonlimiting list including: a computed tomography imaging system, a magnetic resonance imaging system, a positron emission imaging system, and an ultrasound imaging system. Additionally, the method 200 may be performed using 3D data on a workstation or a processor that is separate from a medical imaging system.

Referring now to both FIG. 1 and FIG. 2, at step 202 the processor 116 accesses data. The processor 116 may access data from a memory such as the memory 113, or, according to another embodiment, the processor 116 may access the data in real time directly from the beamformer 110 as the data is acquired by the probe 106. The data accessed during step 202 may comprise a frame of ultrasound data. The data may include, for example, values for a number of voxels, or volume pixel elements, for the volume that was imaged. At step 204, the processor 116 generates a volume-rendered image based on the data. According to an embodiment where the ultrasound probe 106 is a 3D sector probe, the ultrasound data may be scan-converted to Cartesian volumes either in a separate step or during the rendering process. The processor 116 may, for example, perform a projection of the data, which is three-dimensional (3D) voxel data in voxel space, onto a two-dimensional (2D) viewing plane. The processor 116 may sum all the voxel values corresponding to a given pixel location in the viewing plane or the processor 116 may apply a weighting function to the voxel values in order to specifically emphasize particular types of tissue during step 204. The weight of each voxel is called the opacity value of the voxel and it may be defined by an opacity function. The opacity function may, for example, be a global monotonically increasing function of the voxel values. The opacity function may also be modulated by local properties, such as a gradient magnitude measured at each voxel location.

At step 206, the processor 116 displays the volume-rendered image generated during step 204 on the display 118. At step 208, a pixel location of suspected noise is identified. In an exemplary embodiment, a user controls the user interface 115, such as a mouse, a trackball, or a joystick, in order to identify the pixel location of suspected noise. The user may look for areas of the volume-rendered image that do not look anatomically correct or the user may rely on experience to identify a pixel location where the pixels exhibit a high probability of containing noise. Then, the user may simply position an on-screen indicator, such as a cursor, an arrow, a cross-hair, and the like over one or more pixels of suspected noise and press a button in order to indicate the pixel location of suspected noise.

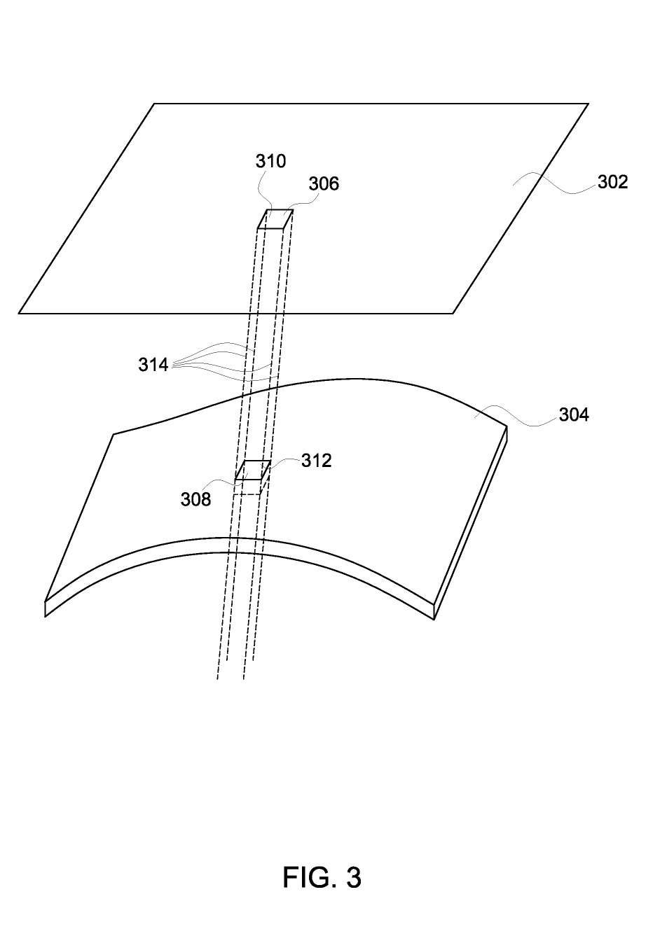

FIG. 3 is a schematic representation showing a perspective view of a viewing plane 302 and a rendered surface 304. A pixel 306 within the viewing plane 302 is shown and a voxel 308 located within the rendered surface 304 is also shown.

Referring now to FIGS. 1, 2, and 3, at step 210 the processor 116 calculates a voxel location corresponding to the pixel location identified during step 208. The pixel values determined for the pixels located in the viewing plane are used when generating the volume-rendered image. In other words, the pixel values within all or a portion of the viewing plane 302 directly affect the volume-rendered image that was displayed during step 206. At step 210, the processor 116 calculates a voxel location corresponding to the pixel location identified during step 208. In FIG. 3, the pixel 306 is positioned at a pixel location 310 while voxel 308 is positioned at voxel location 312. According to an embodiment, the pixel location 310 may be the pixel location of suspected noise identified by the user during step 208. During step 210, the processor 116 calculates a voxel location that both corresponds to the pixel location 310 and intersects the rendered surface 304. For purposes of this disclosure, the term “corresponds” may be used to describe the relationship between a pixel or pixel location and the plurality of voxels or voxel locations that are used to assign a value to the pixel. In other words, all of the voxels or voxel locations location along the ray bound by the dashed lines 314 correspond to the pixel 306 or the pixel location 310 and vice versa. According to an exemplary embodiment, during step 210, the processor 116 calculates the voxel location 312 corresponding to the pixel location 310.

According to an embodiment, as the user presses a button on the user interface 115 of the ultrasound imaging system 100, the processor 116 will receive the pixel location (xₛ,yₛ) of the pointer in the viewing plane 302. The processor 116 may access the depth buffer 117 that contains the distance from the viewing plane to the rendered surface for every pixel location in the viewing plane 302. The processor may use the information in the depth buffer 117 to identify the depth of the rendered surface 304 at the pixel location 310. According to an embodiment, the depth buffer may contain distances from the viewing plane 302 to the rendered surface 304 in a direction perpendicular to the viewing plane. Then, based on the pixel location (xₛ,yₛ) and the information in the depth buffer, the processor 116 can calculate an exact voxel location (xₛ,yₛ,zₛ) that both corresponds to the pixel location and intersects the rendered surface 304.

Still referring to FIGS. 1, 2, and 3, at step 212, the processor 116 implements a region-growing algorithm in voxel space. For purposes of this disclosure, the term “voxel space” is defined to include a coordinate system populated by voxels, where each voxel represents a volume pixel element of the imaged subject matter. Additionally, each voxel may be assigned a discrete value representing a specific characteristic of the imaged subject matter at the location corresponding to the voxel. Voxels and voxel space are well-known by those skilled in the art and will not be described in additional detail.

During step 212, the processor 116 uses the voxel location calculated during step 210 as a seed point for a region-growing algorithm in voxel space. For example, the voxel location 312 may be used as the seed point during an exemplary embodiment. Then, the region-growing algorithm may be used to identify all voxels that are similar and connected to the voxel at the seed point based on a similarity measure, such as opacity value, gradient, or a combination of gradient and opacity value. Region-growing is a well-known image processing technique and it will therefore not be described in additional detail. During step 212, a plurality of voxels are identified. All of the plurality of voxels are connected to the seed voxel and meet the criteria outlined for the similarity measure. Since the seed point for the region-growing algorithm was a voxel of suspected noise, and since the region-growing algorithm was calibrated to capture connected voxels with characteristics similar to the voxel used as the seed point, the plurality of voxels therefore represents a suspected noisy region.

Referring to FIG. 1 and FIG. 2, at step 214, the processor 116 modifies the data in order to generated modified data. The processor 116 may reduce the opacity values of each of the plurality of voxels that were identified with the region-growing algorithm during step 212. According to an embodiment, the processor 116 may assign lower opacity values to the plurality of voxels in the suspected noisy region. For example, each of the plurality of voxels may be assigned an opacity value of zero. If each of the plurality of voxels has an opacity value of zero, then the plurality of voxels in the suspected noisy region will not have any contribution to a volume-rendered image based on the modified data. According to other embodiments, the opacity values of the plurality of voxels may be reduced according a number of different algorithms to a value other than zero. For example, according to another embodiment, the opacity value of each of the plurality of voxels may be reduced as a monotonically decreasing function of the similarity measure f. The opacity value of each of the plurality of voxels may also be reduced according to a function based on distance of the voxel from the seed point. According to another embodiment, a threshold T may be defined so that voxel opacity values are set to zero in locations where the similarity measure f>T. According to another embodiment, opacity values of the plurality of voxels may be determined based on an absolute value of the difference between each of the plurality of voxels and the opacity value of a voxel at the seed point. According to an exemplary embodiment, voxels where the absolute value of the difference is relatively small would have their opacity values reduced more than voxels where the absolute value of the difference is relatively large. It should be appreciated by those skilled in the art that other embodiments may use additional methods to deemphasize voxels in the suspected noisy region.

At step 216, the processor 116 generates a modified volume-rendered image based on the modified data from step 214. At step 218, the modified volume-rendered image is displayed on the display 118. As described hereinabove, the opacity values of the plurality of voxels in the suspected noisy region are reduced in the modified data. Therefore, the modified volume-rendered image should contain less noise than the original volume-rendered image displayed during step 204.

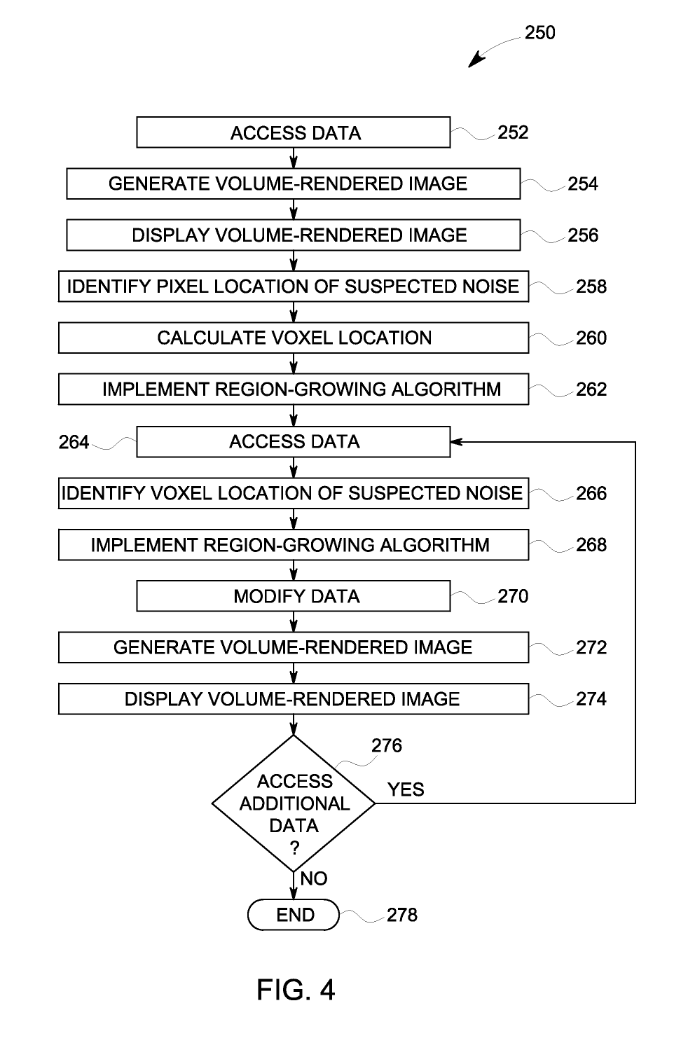

FIG. 4 is a flow chart illustrating a method 250 in accordance with an embodiment. The method 250 may be implemented with a medical imaging system, such as the ultrasound imaging system 100 (shown in FIG. 1). The method 250 may also be implemented with a standalone processor or workstation. The individual blocks represent steps that may be performed in accordance with the method 250. The technical effect of the method 250 is the display of a volume-rendered image generated from modified data. Hereinafter, the method 250 will be described according to an exemplary embodiment using an ultrasound imaging system and ultrasound data, but it should be appreciated that the method 250 may be performed using data from other types of medical imaging systems as well. For example, the method 250 may be performed with a medical imaging system selected from the nonlimiting list including a computed tomography imaging system, a magnetic resonance imaging system, a positron emission imaging system, and an ultrasound system. Steps 252, 254, 256, 258, 260, and 262 in FIG. 4 are very similar to steps 202, 204, 206, 208, 210, and 212 in FIG. 2. Therefore steps 252, 254, 256, 258, 260, and 262 will not be described in detail with respect to FIG. 4.

Referring to FIG. 1 and FIG. 4, at step 252, the processor 116 accesses first data from the memory 113. According to an embodiment, the first data may comprise a first frame of ultrasound data. Those skilled in the art should appreciate that other embodiments my use any type of three-dimensional data acquired with a medical imaging system for the first data. At step 254, the processor 116 generates a volume-rendered image from the first data. At step 256, the processor 116 displays the volume-rendered image on the display 118. At step 258, the user identifies a pixel location of suspected noise in the volume-rendered image. The user may, for example, highlight one or more pixels with an on-screen indicator and press a button to identify the pixel location. According to another embodiment, the user may move the on-screen indicator in an erasing motion, such as in a back-and-forth motion, to indicate and a pixel location suspected to contain noise. At step 260, the processor 116 calculates a voxel location that both corresponds to the pixel location from step 258 and intersects a rendered surface. The processor 116 may calculate the voxel location in the same manner that was described previously with respect to the method 200 shown in FIG. 2. At step 262, the processor 116 implements a region-growing algorithm using the voxel location as a seed point. The region-growing algorithm identifies a plurality of connected voxels that meet a set of commonality criteria. The plurality of connected voxels represent a suspected noisy region.

At step 264, the processor 116 accesses second data from the memory 113. According to an exemplary embodiment, the second data may comprise a second frame of ultrasound data. The second data may be accessed directly from the beamformer 110 or from the memory 113. Next, at step 266, the processor 116 identifies a voxel location of suspected noise. According to an embodiment, the processor 116 may use the same voxel location that was calculated at step 260. Or, according to another embodiment, the processor 116 may calculate another voxel location based on the results of the region-growing algorithm that was implemented during step 262. For example, according to an exemplary embodiment, the center of gravity of the region of the suspected noisy region may be identified as the voxel location during step 266.

At step 268, the processor 116 implements a region-growing algorithm using the voxel location identified at step 266 as a seed point. Even though a voxel location from the first data is used, it should be appreciated that the region-growing algorithm is implemented on the second data. The processor 116 identifies a plurality of voxels that are similar and connected to the seed voxel based on a similarity measure, such as opacity value, gradient of the voxel, or a combination of gradient and opacity value. The plurality of voxels define a region of suspected noise. Region-growing is a well-known image processing technique and it will therefore not be described in additional detail.

At step 270, the processor 116 modifies the data that was accessed at step 264 to generate modified data. According to an embodiment, the processor 116 may reduce the opacity value of each of the plurality of voxels that were identified with the region-growing algorithm during step 262. According to an embodiment, the processor 116 may set the opacity values of each of the voxels in the suspected noisy region to zero. If each of the plurality of voxels have an opacity value of zero, then the plurality of voxels in the suspected noisy region will not have any contribution to a volume-rendered image based on the modified data. According to other embodiments, the opacity values of the plurality of voxels may be reduced to a value other than zero. The opacity values of the voxels may be reduced according to many different algorithms. For example, according to another embodiment, the opacity value of each of the plurality of voxels may be reduced according to a monotonically decreasing function of the similarity measure f. The opacity value of each of the plurality of voxels may also be reduced according to a function based on distance of the voxel from the seed point. According to another embodiment, a threshold T may be defined so that voxel opacity values are set to zero in locations where the similarity measure f>T. It should be appreciated by those skilled in the art that other embodiments may use additional methods to deemphasize voxels in the suspected noisy region.

At step 272, the processor 116 generates a volume-rendered image based on the modified data from step 270. Then, at step 274, the processor 116 displays the volume-rendered image on the display 118. At step 276, the processor 116 determines if it is desired to access additional data. For example, if the ultrasound system 100 is in the process of acquiring live ultrasound data, it may be desired for the processor 116 to access additional data at step 276. Additionally, it may be desired to access additional data if the processor 116 is accessing saved 4D ultrasound data from a memory, such as memory 113. If it is desirable to access additional data, then the method 250 returns to step 264. At step 264, the processor 116 accesses additional data. According to an embodiment, the processor 116 may access data that were acquired at a later time during each successive iteration through steps 264, 266, 268, 270, 272, 274, and 276. According to an embodiment where the method 250 is implemented during the acquisition of live ultrasound data of a structure, the processor 116 may access data that were acquired at a later time during each successive iteration through steps 264, 266, 268, 270, 272, 274, and 276.

According to an exemplary embodiment of the method 250, each successive iteration through steps 264, 266, 268, 270, 272, 274, and 276 may use the results of the region-growing algorithm from the previous iteration through steps 264, 266, 268, 270, 272, 274, and 276 in order to identify the voxel location of suspected noise during step 266. For example, as described hereinabove, during a first iteration through steps 264, 266, 268, 270, 272, 274, and 276 the processor 116 implements a region-growing algorithm at step 268 in order to identify a plurality of voxels in a suspected noisy region. Then, during a second iteration through steps 264, 266, 268, 270, 272, 274, and 276, the processor 116 may use a voxel location selected from the plurality of voxels identified during the region-growing algorithm at step 268 during the first iteration through steps 264, 266, 268, 270, 272, 274, and 276. For example, the processor 116 may use the center of gravity of the plurality of voxels in the suspected noisy region from the first iteration as the voxel location at step 266 of the subsequent iteration. This exemplary embodiment provides an advantage in user workflow. Instead of manually identifying a pixel location of suspected noise and then calculating a voxel location for each iteration through steps 264, 266, 268, 270, 272, 274, and 276, the method 250 is able to rely on previously-calculated suspected noisy regions in order to determine the voxel location, and hence the seed point for the region-growing algorithm, for more recently accessed data. According to this embodiment, the user only needs to manually identify a pixel location of suspected noise on an initial image and then the method will automatically identify suspected noisy regions in voxel space as additional data are acquired and/or accessed. According to an exemplary embodiment, the result will be the display of a live ultrasound image with reduced noise in each of the image frames. An additional benefit of this method is that after the user identifies a pixel of suspected noise, the method seamlessly adjusts voxel opacity values in the suspected noisy region in real-time as additional data are acquired. If at step 276, the processor 116 determines that it is not desired to access additional data, then the method 250 finishes at 278.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A method of reducing noise in a volume-rendered image comprising:
generating a volume-rendered image from data;
identifying a pixel location of suspected noise in the volume-rendered image;
calculating a voxel location that corresponds to the pixel location and intersects a rendered surface in voxel space;
implementing a region-growing algorithm using the voxel location as a seed point to identify a plurality of voxels in a suspected noisy region;
modifying the data to generate modified data by assigning lower opacity values to the plurality of voxels;
generating a modified volume-rendered image from the modified data; and
displaying the modified volume-rendered image.

2. The method of claim 1, wherein said identifying the pixel location of suspected noise comprises moving an on-screen indicator to the pixel location and pressing a button.

3. The method of claim 2, wherein said identifying the pixel location of suspected noise further comprises using a user interface to move the on-screen indicator to the pixel location.

4. The method of claim 1, wherein said modifying the data comprises assigning lower opacity values to each of the plurality of voxels according to a monotonically decreasing function based on distance from the seed point.

5. The method of claim 1, wherein said modifying the data comprises assigning lower opacity values based on an absolute value of the difference between the opacity value of each of the plurality of voxels and the opacity value of a voxel at the seed point.

6. The method of claim 1, wherein the volume-rendered image is generated based on computed tomography data, magnetic resonance imaging data, positron emission tomography data, or ultrasound data.

7. The method of claim 1, wherein said assigning lower opacity values to the plurality of voxels comprises assigning an opacity value of zero to the plurality of voxels.

8. A method of reducing noise in a volume-rendered image comprising:
generating a volume-rendered image from data;
indentifying a pixel location of suspected noise in the volume-rendered image;
accessing a depth buffer to obtain a distance from the pixel location to a rendered surface;
identifying a voxel location associated with the pixel location based on the distance;
implementing a region-growing algorithm using the voxel location as a seed point in order to identify a plurality of voxels in a suspected noisy region;
modifying the data to generate modified data by assigning lower opacity values to the plurality of voxels;
generating a modified volume-rendered image based on the modified data; and
displaying the modified volume rendered image.

9. The method of claim 8, wherein said modifying the data to generate modified data occurs in response to a user input.

10. The method of claim 8, wherein said identifying a pixel location comprises controlling an on-screen indicator in order to select at least one pixel location.

11. The method of claim 10, where said identifying the pixel location further comprises moving the on-screen indicator in an erasing motion.

12. The method of claim 11, wherein said displaying the modified volume-rendered image occurs in real-time in response to said moving the on-screen indicator in an erasing motion

13. A method of reducing noise in a volume-rendered image comprising:
accessing first data, the first data comprising three-dimensional data of a structure;
identifying a voxel location within a suspected noisy region in the first data;
accessing second data, the second data comprising three-dimensional data of the structure acquired after the first data;
implementing a region-growing algorithm on the second data using the voxel location as a seed point in order to identify a plurality of voxels;
modifying the second data to generate modified second data by assigning lower opacity values to the plurality of voxels;
generating a volume-rendered image based on the modified second data; and
displaying the volume-rendered image.

14. The method of claim 13, wherein said identifying the voxel location comprises identifying a center of gravity in the noisy region.

15. The method of claim 13, further comprising acquiring the first data and acquiring the second data with a medical imaging system.

16. The method of claim 15, wherein the first data and the second data both comprise frames of ultrasound data.

17. The method of claim 15, wherein said implementing the region-growing algorithm on the second data occurs in real-time after said acquiring the second data.

18. The method of claim 13, wherein said identifying the voxel location comprises identifying a pixel location on a image generated from the first data.

19. The method of claim 18, wherein said identifying the voxel location comprises calculating the voxel location that corresponds to the pixel location and intersects a rendered surface in voxel space.
